(19) United States
(12) Patent Application Publication
(10) Pub. No.: US 2003/0094171 A1
(43) Pub. Date: May 22, 2003

(54) Cooking grill

(76) Inventors: James E. Harrod, Joplin, MO (US); Wesley H. Ogden, Joplin, MO (US); Raymond A. Caddy, Neosho, MO (US); Michael L. Kidwell, Neosho, MO (US)

Correspondence Address: MARTIN & ASSOCIATES, LLC, P O BOX 548, CARTHAGE, MO, 64836-0548, US

(21) Appl. No.: 10/157,618

(22) Filed: May 29, 2002

Related U.S. Application Data
(63) Continuation-in-part of application No. 09/996,426, filed on Nov. 21, 2001.

(51) Int. Cl. F24C 3/08; A47J 37/00

(52) U.S. Cl. 126/41 R; 126/40; 126/50

(57) ABSTRACT

A portable cooking grill includes a substantially hollow pillar made from structural foam polymer mounted to a base. The top end of the pillar is coupled to a bottom shell where combustion takes place to cook food. A thermal insulator is disposed between the bottom shell and the top end of the pillar to protect the pillar from damage caused by heat generated by the combustion in the bottom shell. The structural foam pillar makes the grill light, easy to clean and maintain, and less costly to produce. The result is a grill that is very attractive and very durable, yet affordable.

This patent application is a continuation-in-part of “Cooking Grill”, U.S. Ser. No. 09/996,426, filed on Nov. 21, 2001, which is incorporated herein by reference.

### BACKGROUND OF THE INVENTION

1. Technical Field

The present invention relates to a cooking grill. More particularly the invention relates to a cooking grill using structural foam plastic as one component of its construction.

2. Background Art

The backyard barbecue is a long established summer pastime in the United States. Gas grills have become very popular because they eliminate the mess and hassle of dealing with charcoal and lighter fluid. A wide variety of designs for gas grills has emerged, from stone, brick, concrete, aluminum, stainless steel and other metals, and, in some limited cases from synthetic materials. Each of these materials have drawbacks as well as advantages.

U.S. Pat. No. 3,581,731 to Schultz discloses an insulated chest that fits within a portable cooking unit. The chest is formed from expanded plastic such as plastic foam. When the cooking unit is to be used, the chest is removed from the firebox, and the cooking unit may then be used to cook food. Schultz does not disclose operating the cooking unit in proximity to the chest, because doing so would threaten to soften or melt the plastic material used in the chest. U.S. Pat. No. 5,154,158 to Lindsey shows a cooler with a recessed area for carrying a grill. The cover of the cooler in Lindsey is stated to be made from or molded of plastic. In both of these prior patents, the grill and chest (or cooler) are separated prior to use. In other words, the plastic material is never in proximity to the heat generated when cooking.

U.S. Pat. No. 4,524,751 to Hoglund is another portable cooking device that includes a housing having two concave sections. A heat barrier is provided within one of the concave sections to protect the plastic from excessive heat during cooking. Yerkes U.S. Pat. No. 6,199,549 shows a wood-fired oven made from non-metal materials, in this case from aluminosilicate compositions.

Straubel et al. U.S. Pat. No. 6,024,082 (hereinafter “Straubel”) discloses an outdoor cooking device in which the support housing is made from a non-metal material which is molded into a hollow thin walled structure. The support housing is in direct contact with the grilling enclosure in some places and is in immediate vicinity to the grilling enclosure in other places. Because of the heat generated by the grilling enclosure, the preferred material in Straubel is a composition of cement, sand and fibers. While Straubel broadly states that other non-metal materials such as concrete, fiberglass, plastic or composite materials may be used, due to the proximity of these materials to the grilling enclosure, they must be able to withstand the heat and stresses associated with outdoor style cooking. The preferred cement-based composition in Straubel satisfies the need for a non-metal material that is sufficiently resistant to heat that it may be placed in contact with or in close proximity to the grilling enclosure.

Straubel requires that the non-metal material be able to withstand the heat associated with outdoor cooking. This drastically limits the suitable materials in Straubel to materials that are relatively expensive. For example, some types of structural foam and composite materials have characteristics that allow their use in Straubel because they have a softening temperature that is high enough that the materials remain unaffected by the heat generated in the grilling enclosure. However, many less expensive materials cannot be used in Straubel due to the proximity to the grilling enclosure. There is therefore a need in the art for a cooking grill that could be manufactured from low-cost materials, yet would provide sufficient heat resistance, compressive and bending strength to provide a safe and affordable grill for use in backyard environments.

### DISCLOSURE OF INVENTION

A portable cooking grill in accordance with the preferred embodiments includes a substantially hollow pillar made from structural foam polymer mounted to a base. The top end of the pillar is coupled to a bottom shell where combustion takes place to cook food. A thermal insulator is disposed between the bottom shell and the top end of the pillar to protect the pillar from damage caused by heat generated by the combustion in the bottom shell. The structural foam pillar makes the grill light, easy to clean and maintain, and less costly to produce. The result is a grill that is very attractive and very durable, yet affordable.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is an exploded, perspective, front view of a grill in accordance with the preferred embodiments of this invention;

FIG. 2 is an exploded, perspective, side view of the grill shown in FIG. 1;

FIG. 3 is an exploded, perspective view of the thermal insulator shown in FIGS. 1 and 2;

FIG. 4 is a perspective, bottom view of the base shown in FIGS. 1 and 2;

FIG. 5 is a perspective view of the pillar shown in FIGS. 1 and 2;

FIG. 6 is a front view of the pillar shown in FIG. 4;

FIG. 7 is a back view of the pillar shown in FIG. 4;

FIG. 8 is a perspective top view of a first configuration for a side table shown in FIGS. 1 and 2 within the scope of the preferred embodiments;

FIG. 9 is a perspective bottom view of the side table shown in FIG. 8;

FIG. 10 is a perspective top view of a second configuration for a side table shown in FIGS. 1 and 2 within the scope of the preferred embodiments;

FIG. 11 is a perspective bottom view of the side table shown in FIG. 10; and

FIG. 12 is a perspective view of the rear of a partially completed grill as shown in FIGS. 1 and 2 that shows the details of how retainer wires may be attached.

### BEST MODE FOR CARRYING OUT THE INVENTION

The cooking grill of the present invention provides a significant improvement over the prior art by providing low-cost non-metal materials that may be used in the grill due to the presence of a thermal insulator that protects the non-metal material from excessive temperatures generated by the grilling enclosure. One suitable example of a non-metal material that may be used within the scope of the preferred embodiment is structural foam. The thermal insulator is preferably disposed between the structural foam pillar and the grilling enclosure. In this manner a low-cost structural foam may be used without threat of softening or melting due to the heat generated in the grilling enclosure.

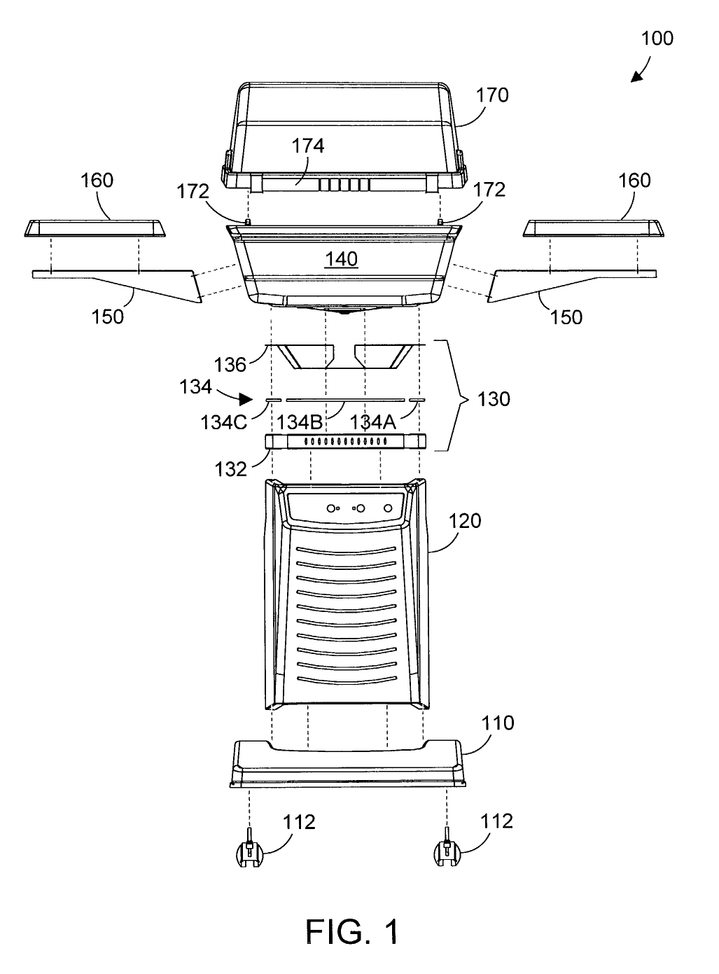

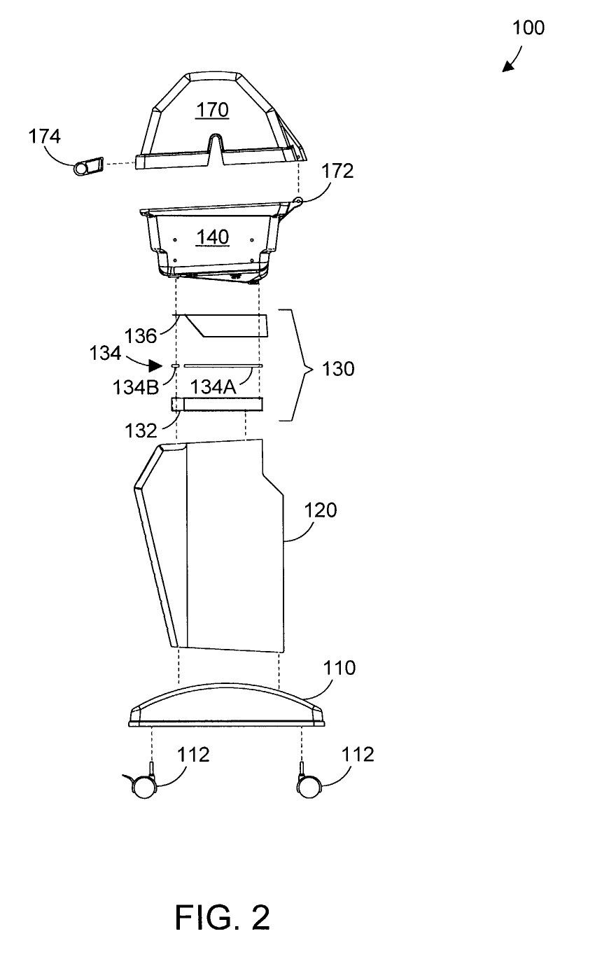

As shown in the drawings, the cooking grill 100 in FIGS. 1 and 2 includes a base 110 and a substantially hollow pillar 120 mounted on base 110. In FIGS. 1 and 2, a dashed line indicates where the parts come together and where fasteners are used. A thermal insulator 130 is disposed between the top of the pillar 120 and a bottom shell 140. Bottom shell 140 is where combustion takes place to cook food. In the preferred embodiments, grill 100 is a gas grill that operates on LP gas. In this configuration, bottom shell 140 will include one or more burners that are coupled to a source of LP gas. Of course, bottom shell 140 could also be used to burn charcoal or other combustible materials. Bottom shell 140 is preferably made of metal, and most preferably made of cast aluminum. However, one skilled in the art will recognize that other suitable materials may be substituted as well.

Pillar 120 is preferably made of a synthetic non-metal material. In the preferred embodiments, pillar 120 is made of a structural foam polymer. The preferred structural foam polymers are foamed polypropylene homopolymer, foamed polyethylene homopolymers and copolymers of these homopolymers, all having good strength and resistance to bending. The polymer should have a flexural modulus of at least 150,000 psi and preferably over 200,000 psi. It should have a hardness of at least 80 on the Rockwell Hardness R scale. A preferred minimum Rockwell Hardness R value is at least 100.

One such polymer is a structural foam polymer formed from Bapolene® Grade 4026 polypropylene homopolymer, which has a flexural Modulus of 200,000 psi, when tested using ASTM test D-790. It has a hardness on the Rockwell Hardness R scale of 100, using ASTM test D-785.

Bapolene® is a registered trademark of Bamberger Polymers, Inc. Bapolene® Grade 4026 is available from Bamberger Polymers Inc., 1983 Marcos Avenue, Lake Success, N.Y. 11042. Another preferred polypropylene for use as the structural foam polymer is Huntsman PP P4G4B-036, manufactured by Huntsman Polymer Corporation. Huntsman PP P4G4B-036 has a flexural Modulus of 231,000 psi and a Rockwell Hardness on the R scale of 108. Both are examples of polymers that can be made into the structural foam components of the present invention.

In one specific configuration illustrated in FIGS. 1-3, the thermal insulator 130 is a three-piece assembly that is disposed between the top of pillar 120 and the bottom of bottom shell 140. In the case of a gas grill that contains one or more burners within bottom shell 140, the heat generated within the bottom shell 140 is considerable. For this reason, the most preferred configuration has the contact area of bottom shell 140 in a horizontal plane that is higher than the highest portion of pillar 120, as shown in FIGS. 1 and 2. The function of thermal insulator 130 is to keep the temperature of the top of the pillar 120 below the softening point of the material of which pillar 120 is made.

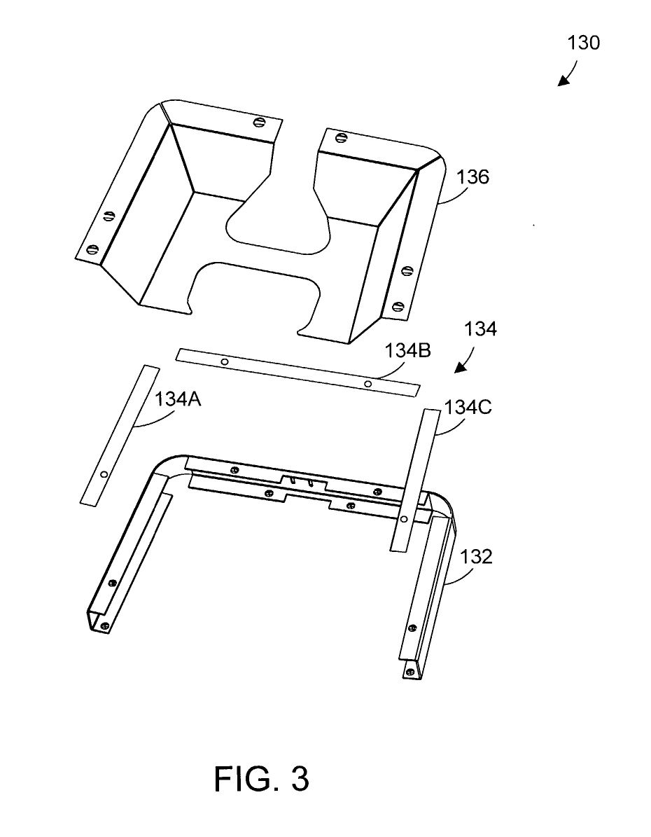

In the particular configuration illustrated in FIG. 1, thermal insulator 130 includes a collar 132, an insulating gasket 134, and a heat shield 136, as shown in more detail in FIG. 3. The collar 132 is preferably channel-shaped, as shown in FIG. 3. The preferred material for collar 132 is sheet metal that can be easily bent to the desired shape. Thin sheet metal is preferred because the thinner the sheet metal in the collar, the less the collar 132 will conduct heat from the bottom shell 140 to the top of the pillar 120. Note that the bottom of collar 132 is attached to the top of pillar 120.

Insulating gasket 134 is any suitable gasket material that provides sufficient thermal insulation between the collar 132 and the heat shield 136. The preferred configuration for gasket 134 is a ceramic material that can withstand at least 1,800° F. This material is a flexible material that may be easily cut to the desired shape. In the preferred embodiments, the gasket 134 includes three separate strips 134A, 134B, and 134C that are placed atop the collar 132, as shown most clearly in FIG. 3. Of course, a one-piece gasket 134 could also be used within the scope of the preferred embodiments.

The insulating gasket 134 of the preferred embodiments is preferably formed from ceramic material capable of resisting a temperature of at least 1800° F. during continuous use. One such gasket material is formed from a woven ceramic having the appearance of paper and including a binder sufficient to create adequate stiffness. Superwool® 607 paper form ceramics has a nominal density of 10 to 13 pcf and is used in thicknesses of about 0.25 inches. It is rated for continuous us at up to 1832° F. and a maximum use limit of 2012° F. Its melting point is 2327° F. Superwool® 607 is formed from 60-70% silica, 25-35% calcium oxide and 4-7% magnesium oxide. Superwool® is a registered trademark of Morgan Crucible Company PLC, and is available from Morgan Crucible Company PLC, Morgan House, Madeira Walk, Windsor, Berkshire SL4 1EP England.

Heat shield 136 is disposed between the bottom shell 140 and the insulating gasket 134. Heat shield 136 is preferably made of a sheet metal that is sufficiently thin to have a low thermal transfer rate. In the specific configuration shown in FIGS. 1 and 2, heat shield 136 serves as a heat barrier to keep the top of a propane tank located within the pillar 120 at an acceptably low temperature. Of course, in other configurations of gas grills, heat shield 136 may not be necessary, or may have different configurations. For example, if the grill is sufficiently tall that there is sufficient air space between the bottom shell 140 and the top of the propane tank, no heat shield would be required. Furthermore, if the propane tank were placed to the side of the pillar 120 instead of within the pillar 120, no heat shield would be necessary. In addition, the heat shield 136 could be in any other suitable configuration, including a slide-out piece of material, a hinged piece of material, or any other suitable configuration that provides a thermal insulating function.

Note that any suitable configuration of a thermal insulator lies within the scope of the preferred embodiments. For example, if the collar 132 were made sufficiently tall, no gasket nor heat shield would be needed. Furthermore, the gasket could be eliminated by coating the heat shield with ceramic material, or by forming the heat shield out of ceramic material. A gasket could also be used without a collar so long as the gasket keeps the temperature of the pillar below its softening point. In addition, a monolithic bottom shell and collar could be fabricated within the scope of the preferred embodiments. In short, the preferred embodiments expressly include any and all configurations of thermal insulators, whether single piece or multi-piece, regardless of the materials used.

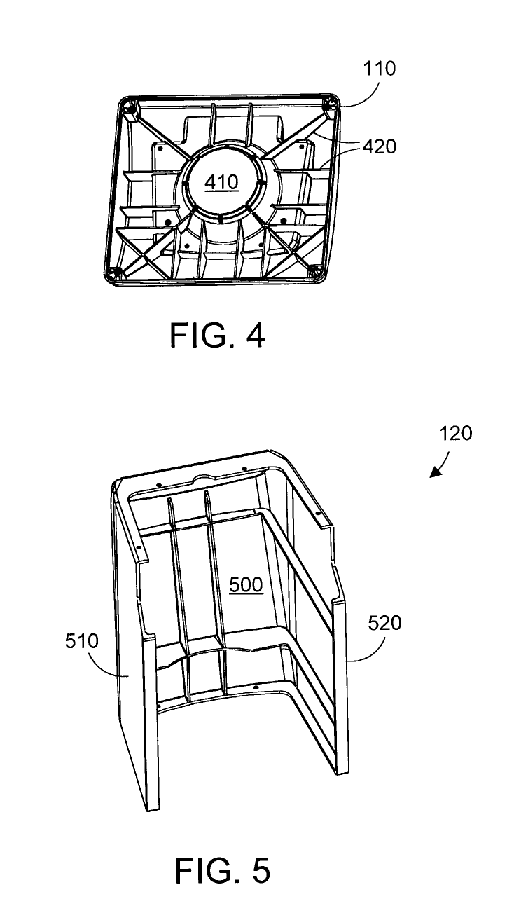

In the preferred embodiments, base 110 is made of structural foam, is rectangular in shape, and includes a plurality of stiffening ribs as shown in FIG. 4 that provide the required structural strength for base 110. Note, however, that the base may be made of other materials and may be in other shapes within the scope of the preferred embodiments.

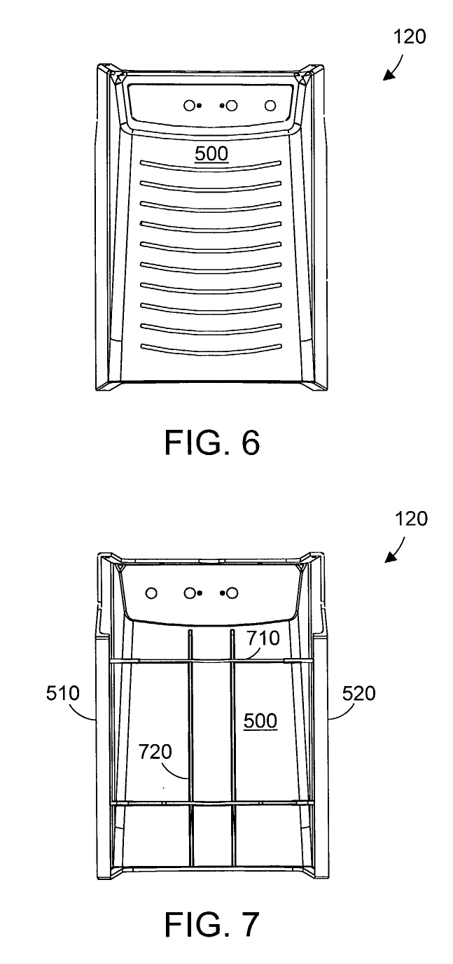

As seen in FIG. 5, the back or inside view of pillar 120 includes a center portion 500 defining the front of the grill and two side portions 510 and 520 respectively, defining opposing side ends of the grill. Pillar 120 preferably has a substantially open back portion so a source of fuel, such as a propane bottle, may be placed through the open part of the back portion to provide fuel for the cooking grill 100. FIGS. 6 and 7 illustrate the front portion 500 with holes for control elements to control the flow of gas to one or more burners.

As can be seen in FIG. 7, pillar 120 may also include a plurality of ribs 710 and 720 in both the horizontal direction from side 510 to side 520, and in the vertical direction from top to bottom of front or center 500. These ribs 710 and 720 form an interlocking rib design that gives structural integrity to the pillar 120 and thus the entire grill. Since the pillar 120 has a substantially open back, it is particularly desirable to have the high flexural modulus of structural foam polymers as described herein. Because pillar 120 is fixedly mounted to base 110, the combination of base 110 and pillar 120, with ribs 420, 710 and 720, provides the strongest grill possible while still permitting pillar 120 to have a substantially open back. Prior art grills do not compare in strength to the grill of this invention and, thus, need to have four sides in an attempt to provide some stability. That fourth side hinders the insertion and removal of the fuel tank, for example, and reduces the ability to keep the grill clean and presentable.

The preferred configuration for pillar 120 is a monolithic piece, as shown in the figures. Note, however, that the preferred embodiments expressly extend to a pillar that is constructed of multiple pieces of structural foam, or that is a combination of structural foam and other materials.

Referring back to FIGS. 1 and 2, a top shell 170 is pivotally mounted to the bottom shell 140 via hinges 172. Top shell 170 includes a handle 174 to permit opening of the top shell 170 when the grill 100 is in use. Cast aluminum is the preferred material for top shell 170, but other metals are also suitable within the scope of the preferred embodiments.

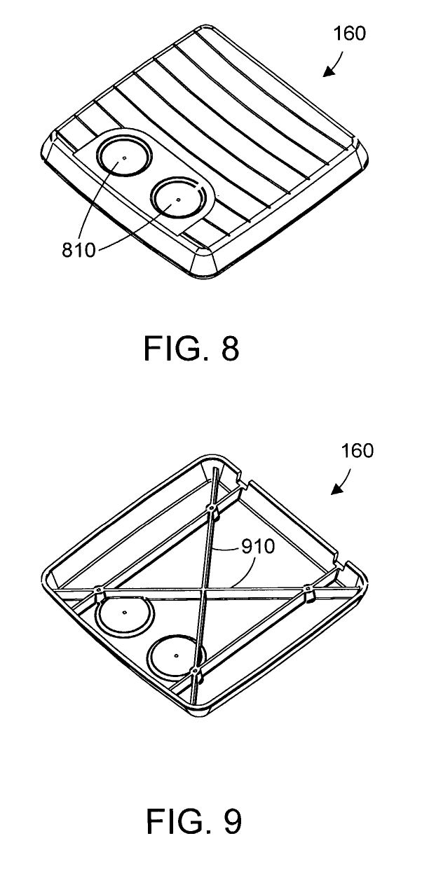

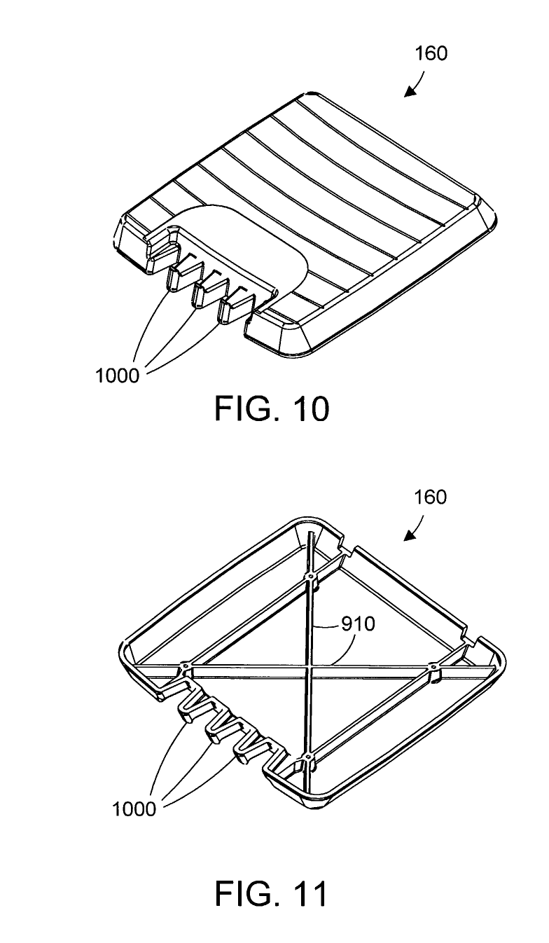

As shown in FIG. 1, shelf brackets 150 are preferably coupled to the bottom shell 120, and support respective side tables 160. In the preferred embodiment, a pair of shelf brackets are used on each side. The preferred material for the side tables 160 is structural foam, but these shelves may be made of any suitable material within the scope of the preferred embodiments. A first specific configuration for a structural foam side table within the scope of the preferred embodiments is shown in FIGS. 8 and 9, which includes cup holders 810 formed therein. A second specific configuration for a structural foam side table within the scope of the preferred embodiments is shown in FIGS. 10 and 11, which includes a plurality of spaced fingers 1000 from which utensils such as a spatula and tongs may be hung. Note that side tables 160 as shown in FIGS. 8-11 include ribs 910, preferably extending diagonally to provide additional strength and resistance to torsion, making the grill very safe. While two side tables 160 are shown in FIG. 1, the preferred embodiments expressly extend to a grill with no side tables or with any suitable number of side tables or other suitable work areas.

Base 110 preferably includes casters 112 to permit movement of the grill to specific locations of choice. Because base 110 and pillar 120 are made from structural foam polymer, there is essentially no measurable torsion when the completed grill is moved, thus reducing significantly the danger or inconvenience of a spill of anything carried on the side tables 160. Base 110 also has a plurality of ribs 420, as shown in FIG. 4, in conjunction with a central collar member 410. Since the polymer has a flexural modulus of at least 150,000 psi and preferably over 200,000 psi, a stable yet portable grill has been produced for the first time. Even metals don't have this resistance to flex in thicknesses that could be economically and practically used.

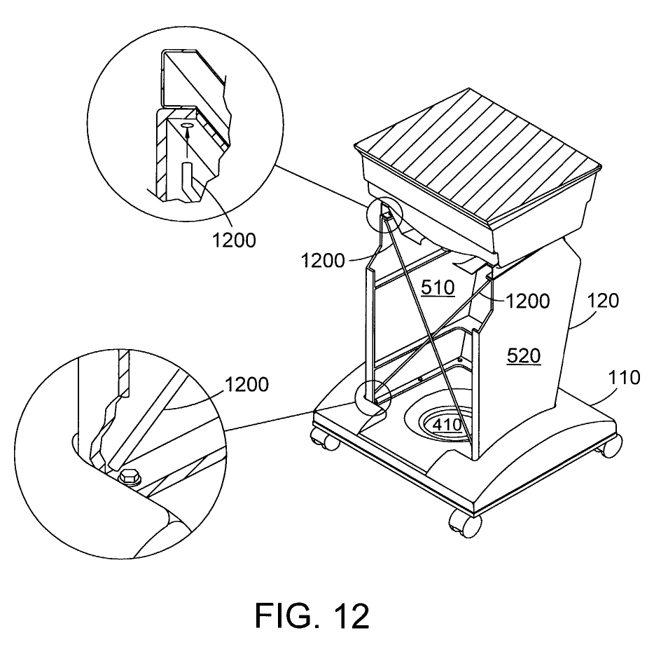

FIG. 12 illustrates the use of two retainer wires 1200 to keep the fuel tank, not shown but sized to fit in collar member 410 of base 110, retained inside pillar 120, and to provide structural support between side portions 510 and 520 of pillar 120. Because the grill is so strong and can be moved with great ease, the retainer wires 1200 provide an additional safety feature to prevent the fuel tank from falling out even when the grill is tipped, such as when being moved up or down stairs or from one level of a deck to another. Note, however, that the preferred embodiments expressly extend to a grill that uses no retainer wires 1200.

The present invention was able to pass, without difficulty, an industry standard test where the grill was operated at maximum burning rate for eight hours a day for six consecutive days without damage. It has also passed all industry standard tests for safety. Additionally, various loads of meats, liquids and other conventional barbecue foods are safely and completely supported on the tables.

While the invention has been particularly shown and described with reference to preferred embodiments thereof, it will be understood by those skilled in the art that various changes in form and details may be made therein without departing from the spirit and scope of the invention.

We claim:

1. A portable grill comprising:
a base;
a substantially hollow structural foam pillar having a bottom end coupled to the base and having a center portion defining the front of the grill and two side portions defining opposing sides of the grill;
a thermal insulator coupled to a top end of the pillar; and
a bottom shell coupled to the thermal insulator, the bottom shell comprising a combustion area.

2. The grill of claim 1 wherein the thermal insulator comprises a piece of sheet metal that spaces the bottom shell from the pillar.

3. The grill of claim 2 wherein the sheet metal is in a channel shape with opposing sides of the channel coupled to the pillar and to the bottom shell.

4. The grill of claim 1 wherein the thermal insulator comprises a thermally insulating gasket.

5. The grill of claim 4 wherein the thermally insulating gasket is formed from ceramic material capable of resisting a temperature of at least 1800° F. during continuous use.

6. The grill of claim 1 wherein the thermal insulator comprises:
a metal pillar collar coupled to the top end of the pillar;
a thermally insulating gasket sized to fit on the collar; and
a metal heat shield having an upper lip in contact with the gasket and coupled to the collar, the heat shield having a tapered front, tapered sides and a flat bottom for reflection of heat in a direction toward the bottom shell.

7. The grill of claim 1 wherein the thermal insulator keeps the top of the pillar at a temperature below a softening point of the structural foam.

8. The grill of claim 7 wherein the softening point for the structural foam is approximately 300° F.

9. The grill of claim 1 wherein the base comprises structural foam.

10. The grill of claim 9 wherein the base has a plurality of ribs on the underside thereof for resisting torsional stress induced in the base.

11. The grill of claim 1 wherein the structural foam is formed from a foamed polymer having a flexural modulus of at least 150,000 psi and a hardness of at least 80 on the Rockwell Hardness R scale.

12. The grill of claim 11 wherein the polymer is polypropylene having a flexural modulus of at least 200,000 psi and a hardness of at least 100 on the Rockwell Hardness R scale.

13. The grill of claim 1 wherein the pillar includes a plurality of support ribs aligned vertically and horizontally to resist bending of the pillar.

14. The grill of claim 1 wherein the pillar has a substantially open back portion.

15. A portable grill comprising:
a base comprising structural foam;
a substantially hollow structural foam pillar having a bottom end coupled to the base and having a center portion defining the front of the grill and two side portions defining opposing sides of the grill;
a metal pillar collar coupled to a top end of the pillar;
a thermally insulating gasket sized to fit on the collar;
a metal heat shield having an upper lip in contact with the gasket and coupled to the collar, the heat shield having a tapered front, tapered sides and a flat bottom for reflection of heat in a direction away from the collar; and
a bottom shell positioned on the upper lip of the metal heat shield, the bottom shell enclosing at least one burner.

16. The grill of claim 15 wherein the thermally insulating gasket is formed from ceramic material capable of resisting a temperature of at least 1800° F. during continuous use.

17. The grill of claim 15 wherein the metal pillar collar comprises sheet metal in a channel shape with opposing sides of the channel coupled to the pillar and coupled to the bottom shell through the thermally insulating gasket and metal heat shield.

18. The grill of claim 15 wherein the metal pillar collar, thermally insulating gasket, and metal heat shield keeps the top of the pillar at a temperature below a softening point of the structural foam.

19. The grill of claim 18 wherein the softening point for the structural foam is approximately 300° F.

20. The grill of claim 15 wherein the base has a plurality of ribs formed in the structural foam on the underside thereof for resisting torsional stress induced in the base.

21. The grill of claim 15 wherein the structural foam is formed from a foamed polymer having a flexural modulus of at least 150,000 psi and a hardness of at least 80 on the Rockwell Hardness R scale.

22. The grill of claim 21 wherein the polymer is polypropylene having a flexural modulus of at least 200,000 psi and a hardness of at least 100 on the Rockwell Hardness R scale.

23. The grill of claim 15 wherein the pillar includes a plurality of support ribs aligned vertically and horizontally to resist bending of the pillar.

24. A portable grill comprising:
a base comprising structural foam that has a plurality of ribs on the underside thereof for resisting torsional stress induced in the base;
a substantially hollow structural foam pillar having a bottom end coupled to the base and having a center portion defining the front of the grill and two side portions defining opposing sides of the grill, the pillar having a substantially open back portion, wherein the structural foam is formed from a foamed polymer having a flexural modulus of at least 200,000 psi and a hardness of at least 100 on the Rockwell Hardness R scale, wherein the pillar includes a plurality of support ribs aligned vertically and horizontally to resist bending of the pillar;
a metal pillar collar coupled to the top end of the pillar;
a thermally insulating gasket sized to fit on the collar;
a metal heat shield having an upper lip in contact with the gasket and coupled to the collar, the heat shield having a tapered front, tapered sides and a flat bottom for reflection of heat in a direction away from the collar; and
a bottom shell coupled through the metal heat shield and thermally insulating gasket to the collar, the bottom shell enclosing at least one burner.

25. The grill of claim 24 wherein the metal pillar collar comprises sheet metal in a channel shape with opposing sides of the channel coupled to the pillar and to the bottom shell.

26. The grill of claim 24 wherein the metal pillar collar, thermally insulating gasket, and metal heat shield keeps the top of the pillar at a temperature below a softening point of the structural foam.

27. The grill of claim 26 wherein the softening point for the structural foam is approximately 300° F.
